(19) United States
(12) Patent Application Publication
(10) Pub. No.: US 2026/0285150 A1
(43) Pub. Date: Sep. 24, 2026

(54) APPARATUS AND METHOD FOR SUPPORTING OFF-ROAD DRIVING AND VEHICLE AND STORAGE MEDIUM INCLUDING THE SAME

(71) Applicants: Hyundai Motor Company, Seoul (KR); Kia Corporation, Seoul (KR)

(72) Inventors: Jun Han KANG, Hwaseong-si (KR); Young II KIM, Hwaseong-si (KR); Da Hoon JEONG, Hwaseong-si (KR); Ji Hun BYUN, Hwaseong-si (KR); Ik Jin UM, Hwaseong-si (KR); In Ho OH, Hwaseong-si (KR)

(73) Assignees: Hyundai Motor Company, Seoul (KR); Kia Corporation, Seoul (KR)

(21) Appl. No.: 19/296,314

(22) Filed: Aug. 11, 2025

(30) Foreign Application Priority Data
Mar. 24, 2025 (KR) 10-2025-0037164

(51) Int. Cl. B60K 28/16

(52) U.S. Cl. CPC B60K 28/165

(57) ABSTRACT

An apparatus for supporting off-road driving includes a controller configured to receive off-road driving data of a vehicle and control whether or when to engage a damper clutch of the vehicle according to damper clutch engagement control data by applying the off-road driving data to a damper clutch engagement control logic, wherein the damper clutch engagement control logic is configured so that whether or when to engage the damper clutch varies according to a possibility of vehicle stuck in off-road terrain based on the off-road driving data.

### CROSS-REFERENCE TO RELATED APPLICATION(S)

This application claims benefit of priority to Korean Patent Application No. 10-2025-0037164 filed on March 24, 2025, in the Korean Intellectual Property Office, the disclosure of which is incorporated herein by reference in its entirety.

### BACKGROUND

The present disclosure relates to an apparatus and method for supporting off-road driving and a vehicle and storage medium including the same.

The number of people who enjoy camping using vehicles and the number of people who enjoy off-road driving sports have continuously increased. Accordingly, a technology allowing for comfortable and safe driving on unpaved off-road terrain other than general paved roads has been required, and thus, various vehicle driving control modes helping to control the driving of vehicles specialized for off-road applications have been developed.

When driving off-road, it is important to drive so that vehicles do not get stuck. Here, a stuck vehicle refers to a vehicle in a state in which the vehicle is stuck in the road surface and cannot move. If a vehicle gets stuck, not only will the vehicle not be able to move, but it may also be very difficult to move the vehicle that has been stuck once again. In particular, in the case of inexperienced drivers, as they try to control the vehicle more strongly to escape from the stuck state, the vehicle may become more stuck, and the stuck vehicle may eventually be freed from the stuck state only by using external force, such as that of a tow truck.

Therefore, when a vehicle is driven off-road, such as on an unpaved road, it is important that the vehicle does not get stuck, that is, unable to move in the road surface.

An aspect of the present disclosure is to provide an apparatus and method for supporting off-road driving and a vehicle and storage medium including the same, configured for preventing a temperature rise in transmission oil of a torque converter (and/or preventing an automatic transmission from being damaged by heat), while effectively reducing the overall final possibility of vehicle stuck in off-road terrain even if road surface severity of the off-road terrain varies.

According to an aspect of the present disclosure, an apparatus for supporting off-road driving includes: a controller configured to receive off-road driving data of a vehicle and control whether or when to engage a damper clutch of the vehicle according to damper clutch engagement control data by applying the off-road driving data to a damper clutch engagement control logic, wherein the damper clutch engagement control logic is configured so that whether or when to engage the damper clutch varies according to a possibility of vehicle stuck in off-road terrain based on the off-road driving data.

The damper clutch engagement control logic may be configured so that when the possibility of vehicle stuck is lower than a damper clutch engagement criterion, the controller is configured to control the damper clutch to an engaged state, and when the possibility of vehicle stuck is higher than the damper clutch engagement criterion, the controller is configured to control the damper clutch to be in an unengaged state.

The damper clutch engagement criterion may include a first damper clutch engagement criterion and a second damper clutch engagement criterion higher than the first damper clutch engagement criterion, and the damper clutch engagement control logic may be configured so that when the possibility of vehicle stuck is higher than the second damper clutch engagement criterion, the controller is configured to control the damper clutch to be in an unengaged state, and when the possibility of vehicle stuck is lower than the second damper clutch engagement criterion, the controller is configured to control the damper clutch to an engaged state, and when the possibility of vehicle stuck is higher than the first damper clutch engagement criterion compared to when the possibility of vehicle stuck is lower than the first damper clutch engagement criterion, the controller is configured to control the damper clutch to an engaged state by further delaying the damper clutch.

The controller may be configured to receive gear shifting level data of the vehicle, and the damper clutch engagement control logic may be configured so that the damper clutch engagement criterion increases as a gear shifting level of the vehicle increases.

The controller may configure off-road type data of the vehicle, and the damper clutch engagement control logic may be configured to determine the damper clutch engagement criterion according to the off-road type data of the vehicle.

The off-road type data may include at least two of snow type data corresponding to a snowy road, sand type data corresponding to a sandy road, and mud type data corresponding to a muddy road, the controller may store a plurality of damper clutch engagement criterion sets, the plurality of damper clutch engagement criterion sets may include at least two of a snow type damper clutch engagement criterion set, a sand type damper clutch engagement criterion set, and a mud type damper clutch engagement criterion set, and the damper clutch engagement control logic may be configured to select one of the plurality of damper clutch engagement criterion sets according to the off-road type data and vary whether to engage the damper clutch based on the damper clutch engagement criterion determined according to the gear shifting level of the vehicle and the possibility of vehicle stuck in the selected damper clutch engagement criterion set.

The damper clutch engagement control logic may be configured so that whether or when the damper clutch is engaged varies depending on the off-road type of the vehicle and the possibility of vehicle stuck.

The controller is configured to receive the gear shifting level data of the vehicle, and the damper clutch engagement control logic may be configured to vary whether or when the damper clutch is engaged depending on the gear shifting level of the vehicle, the off-road type, and the possibility of vehicle stuck.

The controller is configured to receive the off-road driving data from a sensor unit, and the off-road driving data may include at least one of a speed of the vehicle, acceleration of the vehicle, a yaw rate of the vehicle, a yaw acceleration of the vehicle, a steering angle of the vehicle, a number of rotations of a wheel of the vehicle, a torque of the vehicle, and an acceleration input value of the vehicle.

The damper clutch engagement control logic may be configured to periodically determine whether or when to engage the damper clutch at every predetermined determination period, and the determination period may be less than 10 seconds.

The damper clutch engagement control logic may be configured to selectively control whether or when to engage the damper clutch depending on whether an off-road driving mode is used, and the controller may be configured to determine whether to use the off-road driving mode, either manually according to an input or automatically based on the off-road driving data.

According to another aspect of the present disclosure, a method for supporting off-road driving includes: storing a damper clutch engagement control logic of a vehicle based on a possibility of vehicle stuck in off-road terrain; receiving off-road driving data of the vehicle; and controlling whether or when to engage a damper clutch of the vehicle by applying the off-road driving data to the damper clutch engagement control logic.

The damper clutch engagement control logic may be configured to control the damper clutch to an engaged state when the possibility of vehicle stuck is lower than a damper clutch engagement criterion and to control the damper clutch to an unengaged state when the possibility of vehicle stuck is higher than the damper clutch engagement criterion.

The receiving may include receiving gear shifting level data of the vehicle, and the damper clutch engagement control logic may be configured so that the damper clutch engagement criterion is determined according to a gear shifting level of the vehicle and off-road type.

The off-road type data may include at least two of snow type data corresponding to a snowy road, sand type data corresponding to a sandy road, and mud type data corresponding to a muddy road, the storing may include storing a plurality of damper clutch engagement criterion sets, the plurality of damper clutch engagement criterion sets may include at least two of a snow type damper clutch engagement criterion set, a sand type damper clutch engagement criterion set, and a mud type damper clutch engagement criterion set, and the damper clutch engagement control logic may be configured to select one of the plurality of damper clutch engagement criterion sets according to the off-road type data and vary whether to engage the damper clutch based on the damper clutch engagement criterion determined according to the gear shifting level of the vehicle and the possibility of vehicle stuck in the selected damper clutch engagement criterion set.

According to another aspect of the present disclosure, there is provided a storage medium having recorded thereon one or more programs including instructions for executing a method for supporting off-road driving.

According to another aspect of the present disclosure, a vehicle includes: a controller including a processor and a storage medium having recorded thereon one or more programs configured to be executable by the processor, wherein the one or more programs include instructions for executing the method for supporting off-road driving.

According to another aspect of the present disclosure, a vehicle includes: an automatic transmission including a damper clutch and a torque converter; a sensor unit detecting off-road driving data; and a controller configured to control whether or when to engage the damper clutch according to damper clutch engagement control data by applying the off-road driving data to a damper clutch engagement control logic, wherein the damper clutch engagement control logic is configured to vary whether or when to engage the damper clutch according to a possibility of vehicle stuck in off-road terrain based on the off-road driving data.

The controller is configured to receive gear shifting level data of the vehicle from the sensor unit, and the damper clutch engagement control logic may be configured to vary whether or when to engage the damper clutch depending on a gear shifting level of the vehicle, an off-road type, and the possibility of vehicle stuck.

The damper clutch engagement control logic may be configured so that when the possibility of vehicle stuck is lower than a damper clutch engagement criterion, the controller is configured to control the damper clutch to an engaged state, and when the possibility of vehicle stuck is higher than the damper clutch engagement criterion, the controller is configured to control the damper clutch to be in an unengaged state.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 and FIG. 2 are diagrams illustrating an apparatus for supporting off-road driving and a vehicle according to an exemplary embodiment of the present disclosure;

FIG. 3 is a block diagram specifically illustrating a controller and a sensor unit of an apparatus and method for supporting off-road driving and a vehicle and a storage medium according to an exemplary embodiment of the present disclosure;

FIG. 4 is a diagram illustrating damper clutch engagement control according to the possibility of vehicle stuck of an apparatus and method for supporting off-road driving and a vehicle and a storage medium according to an exemplary embodiment of the present disclosure;

FIG. 5 is a flowchart illustrating a method for supporting off-road driving according to an exemplary embodiment of the present disclosure;

FIG. 6 is a flowchart illustrating an operation of an apparatus and method for supporting off-road driving and a vehicle and a storage medium based on a damper clutch engagement criterion according to an exemplary embodiment of the present disclosure;

FIG. 7 is a flowchart illustrating an operation in which a damper clutch engagement criterion of an apparatus and method for supporting off-road driving and a vehicle and a storage medium is determined according to off-road type data and/or gear shifting level according to an exemplary embodiment of the present disclosure;

FIG. 8 is a graph illustrating an operation in which a damper clutch engagement criterion of an apparatus and method for supporting off-road driving and a vehicle and a storage medium is determined according to off-road type data according to an exemplary embodiment of the present disclosure;

FIG. 9 and FIG. 10 are diagrams illustrating a plurality of damper clutch engagement criterion sets of an apparatus and method for supporting off-road driving and a vehicle and a storage medium according to an exemplary embodiment of the present disclosure; and

FIG. 11 is a flowchart illustrating an operation of an apparatus and method for supporting off-road driving and a vehicle and a storage medium based on first and second damper clutch engagement criterion according to an exemplary embodiment of the present disclosure.

### DETAILED DESCRIPTION

While the present disclosure may be modified in various ways and take on various alternative forms, specific embodiments thereof are shown in the drawings and described in detail below. However, it should be understood that there is no intent to limit the present disclosure to the particular forms disclosed, but on the contrary, the present disclosure covers all modifications, equivalents, and alternatives falling within the spirit and scope of the present disclosure.

It will be understood that, although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of one or more of the associated listed items.

The terms used herein to describe embodiments of the present disclosure is not intended to limit the scope of the present disclosure. The articles “a,” and “an” are singular in that they have a single referent, however the use of the singular form in the present specification should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different way, all the terms used herein including technical and scientific terms have the same meanings as understood by those skilled in the art to which the present disclosure pertains. Such terms as defined in generally used dictionaries should be construed to have the same meanings as those of the contexts of the related art, and unless clearly defined in the application, they should not be construed to have ideally or excessively formal meanings.

In the present specification, vehicles refer to a variety of vehicles that move transported objects, such as people, animals, or goods, from a starting point to a destination. These vehicles are not limited to vehicles that run on roads or tracks.

Hereinafter, embodiments of the present disclosure will be described with reference to the accompanying drawings.

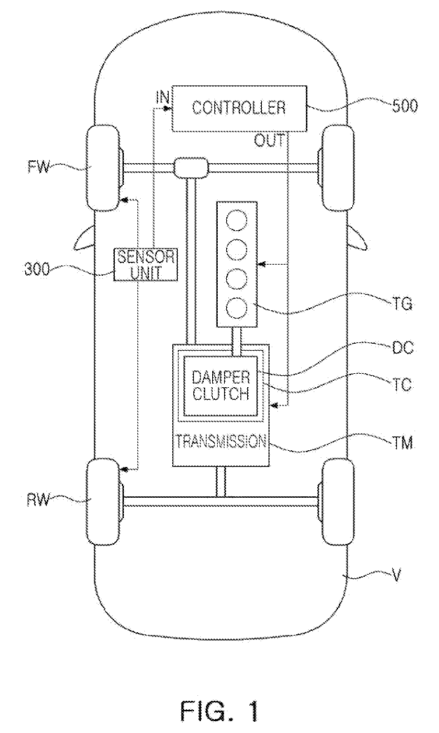

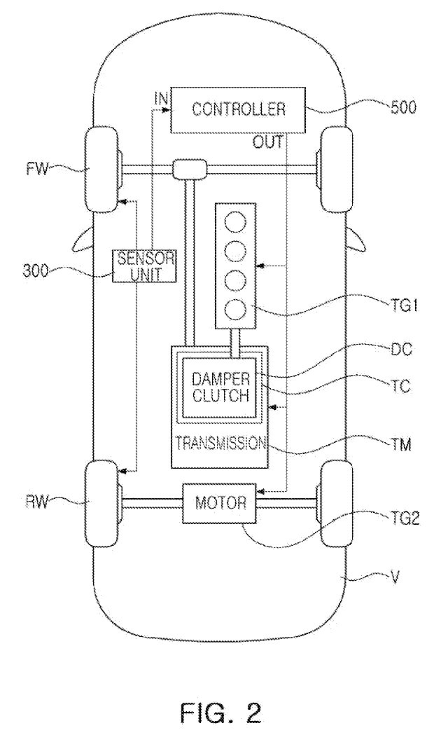

Referring to FIG. 1, a vehicle V may include an internal combustion engine vehicle including an engine TG. Referring to FIG. 2, the vehicle V may include a hybrid electric vehicle (including a plug-in hybrid electric vehicle) including an engine TG1 and a motor TG2. The configuration (e.g., number, position, connection relationship, etc.) of the motor TG2 is not limited.

Referring to FIGS. 1, 2, and 3, the vehicle V according to an exemplary embodiment of the present disclosure may include an automatic transmission TM, a sensor unit 300, and a controller 500. The automatic transmission TM may include a damper clutch DC and a torque converter TC, and the torque converter TC may include a damper clutch DC. For example, the damper clutch DC may be defined as a lock-up clutch. For example, the controller 500 may include a vehicle control unit (VCU) and/or a microcontroller unit (MCU).

The automatic transmission TM may include a plurality of gears each respectively corresponding to different gear shifting levels (e.g., first gear, second gear), may automatically change the gear shifting levels (e.g., first gear, second gear) of the vehicle V according to a predetermined shift pattern, and may use a selected gear among the plurality of gears. For example, the predetermined shift pattern may include a plurality of gear shifting criterion based on at least one of the speed, torque, and acceleration input value (e.g., a throttle opening rate) of the vehicle V, and the automatic transmission TM may perform a gear shifting (e.g., shifting from a first gear to a second gear, shifting from the second gear to the first gear) corresponding to one of the plurality of gear shifting criterion when at least one of real-time speed, real-time torque, and real-time acceleration input values of the vehicle V satisfies one of the plurality of gear shifting criterion.

The sensor unit 300 may monitor (always sense) at least one of the real-time speed, real-time torque, and real-time acceleration input values. A transmission control unit (TCU) may store the predetermined shift pattern in advance, receive at least one of the real-time speed, real-time torque, and real-time acceleration input values from the sensor unit 300, and control automatic change of a gear shifting level (e.g., first gear, second gear) based on the values received from the sensor unit 300 and the predetermined shift pattern. The TCU may be disposed in the controller 500 and/or the automatic transmission TM.

A torque converter TC may transmit torque between a gear selected among the plurality of gears and the engine (TG, TG1), and may change driving force corresponding to the torque according to driving resistance of the vehicle V. The torque converter TC may include transmission oil for fluid coupling of the gear.

When the damper clutch DC is not engaged, the torque converter TC may stably secure the driving force through the fluid coupling. When the damper clutch DC is engaged, the damper clutch DC may mechanically transmit torque between the engine (TG, TG1) and the gear by replacing the fluid coupling of the gear, so that energy loss due to the fluid coupling may be reduced. Furthermore, when the damper clutch DC is engaged, continuous slip of the damper clutch DC may be prevented, and thus, a temperature rise of the transmission oil due to the continuous slip may be prevented.

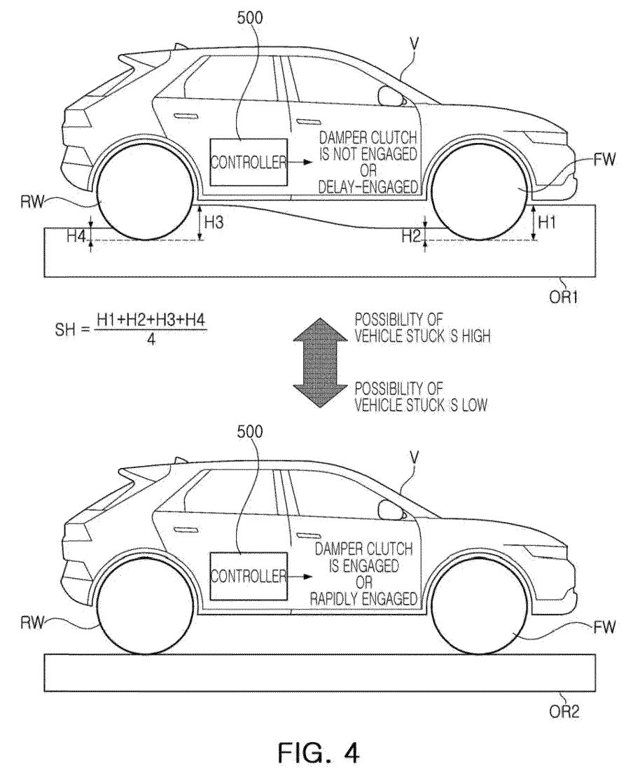

Referring to FIG. 4, the vehicle V may drive on off-roads OR1 and OR2. The off-roads OR1 and OR2 may include a non-road surface (e.g., a snowy road, a muddy road, a sandy road) and may include a road with a bad road condition. Unlike an ideal road, road surface severity of the off-road terrains OR1 and OR2 may vary. For example, a major factor of road surface severity may include a road surface level deviation SH, and the road surface level deviation SH may be an average of a front level H1 of a front wheel FW, a rear level H2 of the front wheel FW, a front level H3 of a rear wheel RW, and a rear level H4 of the rear wheel RW, and the reference for the levels H1, H2, H3, and H4 may be, but is not limited to, the lowest level of the road surface.

However, the road surface severity may include additional factors (e.g., a change in road surface level deviation according to wheel torque, etc.) in addition to the road surface level deviation SH. For example, snow, mud, and sand may have different particle bonding strengths, so that the change in road surface level deviation according to wheel torque may be different in snow terrain, mud terrain, and sand terrain.

As the road surface severity (e.g., a road surface level deviation and/or a road surface level deviation change according to the torque of the wheel) of the off-roads OR1 and OR2 is higher, the possibility that a front wheel FW and/or a rear wheel RW of the vehicle V will get stuck at a specific point (e.g., a point at which a level slope is the steepest) of the off-roads OR1 and OR2 and cannot get out from the specific point (i.e., the possibility of vehicle stuck) may increase.

For example, the level deviation SH of the off-road OR1 may be greater than that of the off-road OR2, the road surface severity of the off-road terrain OR1 may be greater than that of the off-road OR2, and the possibility of the vehicle V getting stuck on the off-road OR1 may be higher than that of the vehicle V getting stuck on the off-road OR2.

The sensor unit 300 may detect off-road driving data. For example, the off-road driving data may include at least one of a speed of the vehicle V (a sensing value of a vehicle speed sensor 302 of the sensor unit 300), an acceleration of the vehicle V (a sensing value of an acceleration sensor 305 of the sensor unit 300), a yaw rate of the vehicle V (a sensing value of a yaw rate sensor 301 of the sensor unit 300), a yaw acceleration of the vehicle V (a sensing value of the yaw acceleration sensor 304 of the sensor unit 300), a steering angle of the vehicle V (a sensing value of a steering angle sensor 307 of the sensor unit 300), revolutions per minute (rpm) of the wheels (the front wheel FW and/or the rear wheel RW) of the vehicle V (a sensing value of a wheel speed sensor 303 of the sensor unit 300), a torque of the vehicle V (a sensing value of a torque sensor 306 of the sensor unit 300), and an acceleration input value of the vehicle V (a sensing value of an APS sensor 308 of the sensor unit 300). The sensor unit 300 may include at least one of the vehicle speed sensor 302, the acceleration sensor 305, the yaw rate sensor 301, the yaw acceleration sensor 304, the steering angle sensor 307, the wheel speed sensor 303, the torque sensor 306, and the APS sensor 308.

The torque of the vehicle V may include a torque of the engine (or motor) and/or a torque of the wheels (the front wheel FW and/or the rear wheel RW). The acceleration of the vehicle V may include a longitudinal acceleration of the vehicle V and/or a lateral acceleration of the vehicle V. The yaw rate is a speed at which the posture of the vehicle V rotates in the yaw direction, and the yaw direction is a direction in which the vehicle V faces the ground (e.g., the direction of gravity). The APS of the APS sensor 308 may be an accelerator pedal sensor.

The apparatus for supporting off-road driving and the controller 500 of the vehicle V according to an exemplary embodiment of the present disclosure may receive the off-road driving data IN of FIGS. 1 and 2 from the sensor unit 300 of FIGS. 1 and 2 and may be configured to control whether or when a damper clutch DC of FIGS. 1 and 2 is engaged according to damper clutch engagement control data OUT of FIGS. 1 and 2 by applying off-road driving data to a damper clutch engagement control logic. The damper clutch engagement control logic may be configured to change whether (e.g., not engaged, engaged) or when (e.g., delayed engagement, rapid engagement) the damper clutch DC of FIGS. 1 and 2 is engaged depending on the possibility (e.g., high, low) of the vehicle V getting stuck on the off-roads OR1 and OR2 based on the off-road driving data.

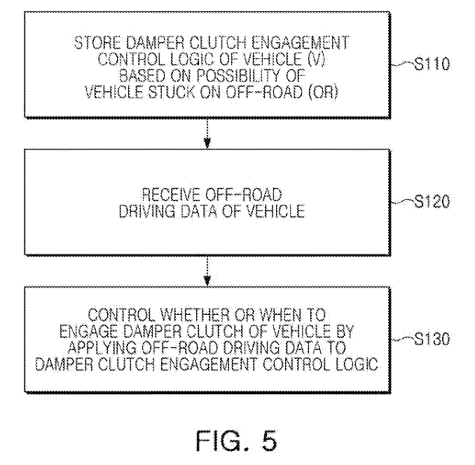

Referring to FIGS. 4 and 5, a method for supporting off-road driving according to an exemplary embodiment of the present disclosure may include an operation S110 in which the controller 500 stores the damper clutch engagement control logic of the vehicle V based on a possibility of the vehicle V getting stuck on the off-road (OR); an operation S120 in which the controller 500 receives off-road driving data of the vehicle V; and an operation S130 in which the controller 500 is configured to control whether or when the damper clutch DC of FIGS. 1 and 2 of the vehicle V is engaged by applying the off-road driving data to the damper clutch engagement control logic.

For example, since the possibility of the vehicle V getting stuck on the off-road OR1 may be high, the controller 500 may be configured for controlling the damper clutch DC of FIGS. 1 and 2 to be unengaged or to be delay-engaged in a situation in which the vehicle V has the possibility to be stuck, reducing the possibility of the vehicle V being finally stuck by utilizing the stably secured driving force.

For example, since the possibility of the vehicle V getting stuck on the off-road OR2 may be low, the controller 500 may be configured for controlling the damper clutch DC of FIGS. 1 and 2 to be engaged or to be rapidly engaged, preventing continuous slipping of the damper clutch DC of FIGS. 1 and 2, preventing temperature rise of the transmission oil of the torque converter TC of FIGS. 1 and 2 due to the continuous slipping and reducing energy loss.

Accordingly, the apparatus for supporting off-road driving and the vehicle V according to an exemplary embodiment of the present disclosure may effectively reduce the overall final possibility of vehicle stuck on the off-roads OR1 and OR2 even when the road surface severity of the off-road terrains OR1 and OR2 varies, while preventing a temperature rise of the transmission oil of the torque converter TC of FIGS. 1 and 2 and increasing energy efficiency. Furthermore, as the temperature rise of the transmission oil is prevented, the automatic transmission TM of FIGS. 1 and 2 may be prevented from being damaged by heat and the lifespan of the automatic transmission TM of FIGS. 1 and 2 may also be lengthened.

For example, when the temperature of the transmission oil is too high (e.g., when the temperature value of the transmission oil detected by the sensor unit 300 exceeds a reference temperature), the controller 500 may be configured for controlling the damper clutch DC of FIGS. 1 and 2 to be engaged more preferentially according to a separate transmission protection logic (which may be stored in advance in the controller 500). At the instant time, driving force may be reduced. Since the controller 500 may prevent an unnecessary increase in the temperature of the transmission oil whenever the possibility of vehicle stuck is low, the occurrence of a situation in which both the temperature of the transmission oil and the possibility of vehicle stuck are high may be minimized, and the final possibility of vehicle V stuck may be stably reduced.

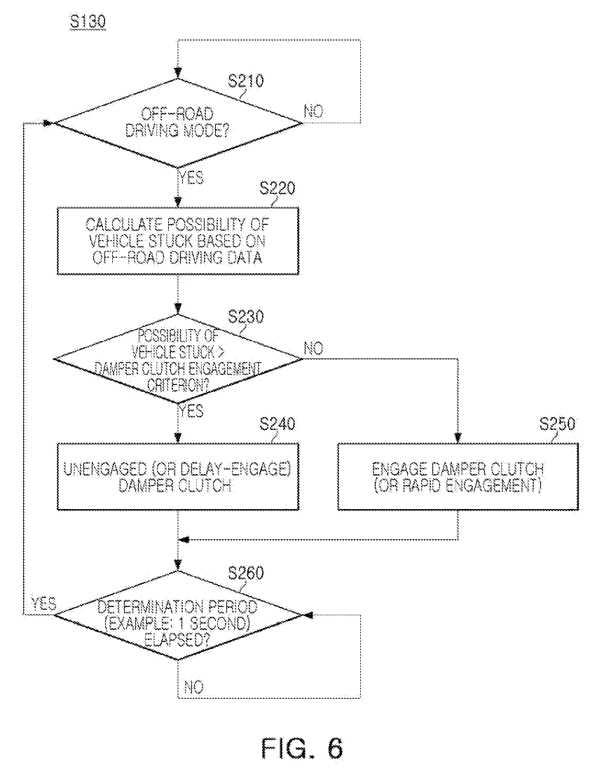

Referring to FIGS. 4 and 6, the damper clutch engagement control logic may be configured to determine (S220) the possibility of vehicle stuck (e.g., stuck score data) based on off-road driving data. For example, the damper clutch engagement control logic may include logic (e.g., equations for the determination) for determining the possibility of vehicle stuck (e.g., stuck score data).

For example, to increase the accuracy of determining (or estimating) the possibility of vehicle stuck from off-road driving data, vehicle (prototype) driving experiments on various off roads may be conducted cumulatively. In the present process, the controller 500 may gradually optimize (e.g., optimization of coefficients and constants of equations for the determination) the logic (which may be included in the damper clutch engagement control logic) for determining the possibility of vehicle stuck (e.g., stuck score data) from off-road driving data.

For example, the controller 500 may further increase the accuracy of the possibility of vehicle stuck by determining parameter data between the off-road driving data and the possibility of vehicle stuck. For example, the parameter data may include a slip ratio of the wheel (the front wheel FW and/or the rear wheel RW) and/or a coefficient of friction for off-road. The slip ratio may be defined as a value obtained by dividing a difference between the number of rotations of the wheels (front wheels FW and/or rear wheels RW) and the speed of the vehicle V by the number of rotations or the speed. The coefficient of friction may be defined by a different equation than the slip ratio.

For example, in a situation in which the vehicle V has a possibility to become stuck, a load of the wheels (front wheels FW and/or rear wheels RW) may be reduced, and as the load is reduced, the slip ratio may be increased. The slip ratio may also be increased when the coefficient of friction is reduced. As the value obtained by dividing the slip ratio by the coefficient of friction increases, the road surface severity may be increased and the possibility of vehicle stuck may be increased. Therefore, the controller 500 may accurately estimate the possibility of vehicle stuck (e.g., stuck score data) based on at least one of the slip ratio, the coefficient of friction, and the road surface severity.

The damper clutch engagement control logic may be configured to selectively (YES/NO in S210) control whether or when the damper clutch is engaged, depending on whether the off-road driving mode is used. The controller 500 may be configured to determine whether the off-road driving mode is used, either manually according to input (e.g., a mode setting method through manual input by a driver) or automatically based on the off-road driving data (e.g., a method of setting a mode by automatically determining whether the minimum criterion for road surface severity or possibility of vehicle stuck is reached).

Accordingly, the possibility that other control logic used when the vehicle V is not driving on an off-road conflict with the damper clutch engagement control logic may be prevented in advance. For example, the controller 500 may deactivate the off-road driving mode when the vehicle V is driving on a paved road and may activate the off-road driving mode when the vehicle V is driving on an off-road.

The damper clutch engagement control logic may be configured so that if the possibility of vehicle stuck is lower than the damper clutch engagement criterion (NO in S230), the controller 500 is configured to control the damper clutch to an engaged state (or rapid engagement) (S250), and if the possibility of vehicle stuck is higher than the damper clutch engagement criterion (YES in S230), the controller 500 is configured to control the damper clutch to be in an unengaged state (or delayed engagement) (S240).

The damper clutch engagement control logic may be configured to periodically (S260) determine whether or when to engage the damper clutch at every predetermined determination period. Accordingly, the damper clutch engagement control accuracy/reliability may be further improved. For example, the determination period may be less than 10 seconds (e.g., 1 second), but is not limited thereto. A lower limit of the determination period (e.g., 0.1 seconds, 0.01 seconds) may vary depending on the performance of the controller 500.

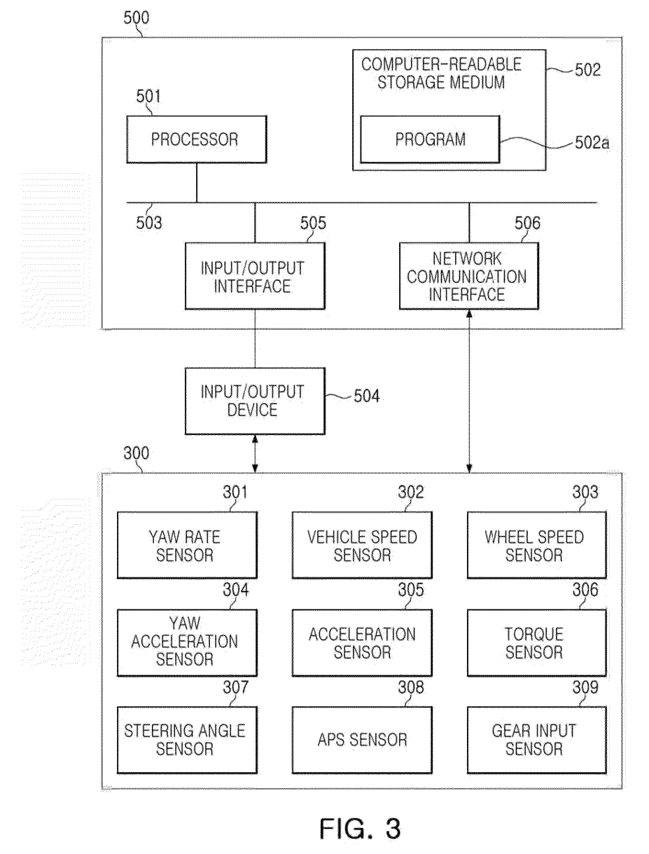

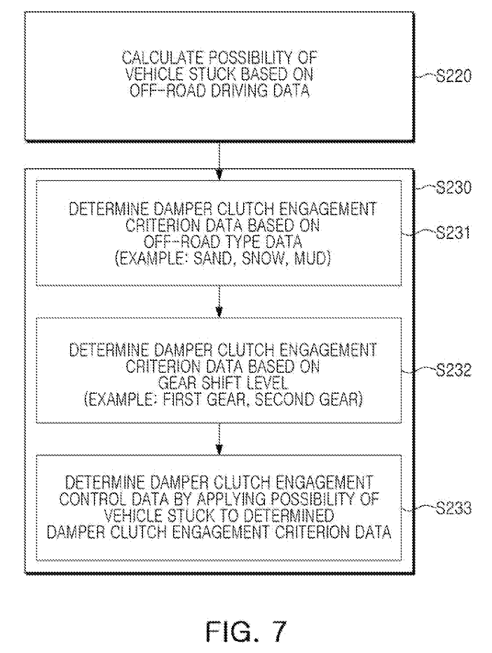

Referring to FIGS. 6 and 7, the damper clutch engagement control logic may be configured to determine S231 the damper clutch engagement criterion according to the off-road type data (e.g., sand, snow, mud) of the vehicle V and may be configured to determine S232 the damper clutch engagement criterion data based on a gear shifting level of the vehicle V (e.g., a sensing value of a gear input sensor 309 of the sensor unit 300 of FIG. 3). The damper clutch engagement control logic may be configured to vary whether or when the damper clutch DC of FIGS. 1 and 2 is engaged depending on the off-road type and/or gear shifting level of the vehicle V and the possibility of vehicle stuck. For example, the controller 500 may configure off-road type data of the vehicle V (e.g., generate according to a separate control logic, such as terrain mode, or generate through manual input by the driver) prior to receiving off-road driving data and may further receive gear shifting level data from the gear input sensor 309 of the sensor unit 300 of FIG. 3 while receiving the off-road driving data.

Accordingly, the accuracy/reliability of the damper clutch engagement control may be further improved. For example, as the gear shifting level of the vehicle V increases, the vehicle V may be in a situation in which driving force demand is lower, so that the appropriate damper clutch engagement criterion may become higher as the gear shifting level increases. Accordingly, the damper clutch engagement control logic may be configured so that the damper clutch engagement criterion becomes higher as the gear shifting level of the vehicle V increases.

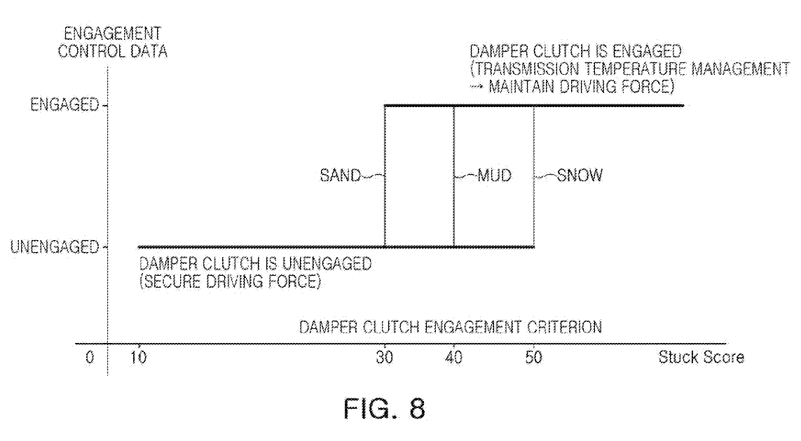

Referring to FIGS. 7 and 8, the off-road type data may include at least two of snow type data (SNOW) corresponding to a snowy road, sand type data (SAND) corresponding to a sandy road, and a mud type data (MUD) corresponding to a muddy road. The damper clutch engagement criterion e.g., 50 of the snow type data (SNOW), the damper clutch engagement criterion e.g., 40 of the mud type data (MUD), and the damper clutch engagement criterion e.g., 30 of the sand type data (SAND) may be different from each other but are not limited thereto.

For example, driving force required to prevent vehicle stuck on the muddy road may be less than driving force required to prevent vehicle stuck on the sandy road, and driving force required to prevent vehicle stuck on the snowy road may be less than driving force required to prevent vehicle stuck on the muddy road. Therefore, the damper clutch engagement criterion e.g., 40 of the mud type data (MUD) may be higher than the damper clutch engagement criterion e.g., 30 of the sand type data (SAND), and the damper clutch engagement criterion e.g., 50 of the snow type data (SNOW) may be higher than the damper clutch engagement criterion e.g., 40 of the mud type data (MUD). Accordingly, the damper clutch engagement control accuracy/reliability may be further improved.

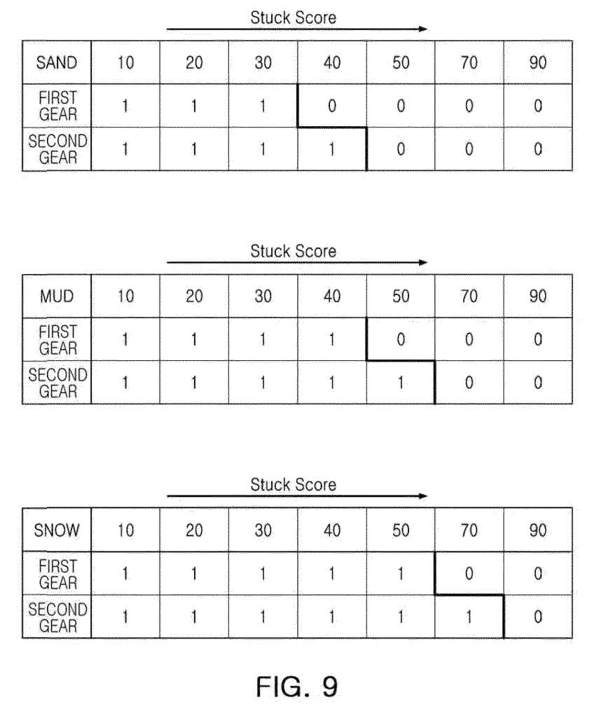

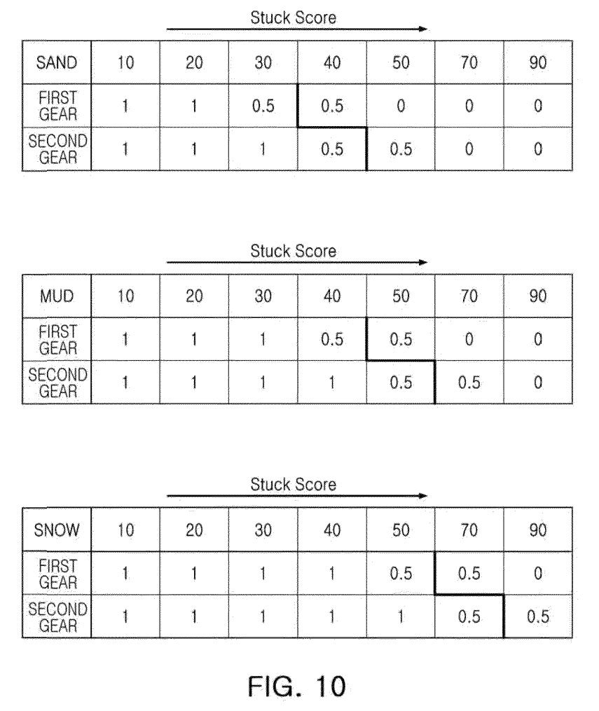

Referring to FIGS. 9 and 10, the controller may store a plurality of damper clutch engagement criterion sets (e.g., two-dimensional data including a gear shifting level and the possibility of vehicle stuck (stuck score) or one-dimensional data including the possibility of vehicle stuck (stuck score), and the plurality of damper clutch engagement criterion sets may include at least two of a snow type damper clutch engagement criterion set (for SNOW), a sand type damper clutch engagement criterion set (for SAND), and a mud type damper clutch engagement criterion set (for MUD).

For example, 0 of the engagement control data may correspond to damper clutch non-engagement (e.g., non-engagement prior to separate logic, such as terrain mode), 1 of the engagement control data may correspond to damper clutch engagement (e.g., an engagement status may be changed according to separate logic, such as the terrain mode), and a boundary line between 0 and 1 of the engagement control data may correspond to a damper clutch engagement criterion. For example, when the plurality of damper clutch engagement criterion sets are N-dimensional data, the plurality of damper clutch engagement criterion sets may be configured as a damper clutch engagement criterion set of single (N+1)-dimensional data.

For example, the damper clutch engagement control logic may be configured to select one of the plurality of damper clutch engagement criterion sets according to the off-road type data (corresponding to S231 in FIG. 7) and vary whether to engage the damper clutch based on the damper clutch engagement criterion determined according to the gear shifting level of the vehicle (corresponding to S232 in FIG. 7) and the possibility of vehicle stuck (corresponding to S233 in FIG. 7) in the selected damper clutch engagement criterion set. Accordingly, the possibility of confusion occurring between input variables (e.g., off-road type, gear shifting level, possibility of vehicle stuck) which may be used for damper clutch engagement control may be prevented in advance.

Referring to FIG. 10, depending on the design, the damper clutch engagement criterion may include a first damper clutch engagement criterion (a boundary line between 0 and 0.5 of the engagement control data) and a second damper clutch engagement criterion (a boundary line between 0.5 and 1 of the engagement control data) which is higher than the first damper clutch engagement criterion. 0.5 of the engagement control data may correspond to damper clutch delay engagement, and 1 of the engagement control data may correspond to damper clutch rapid engagement.

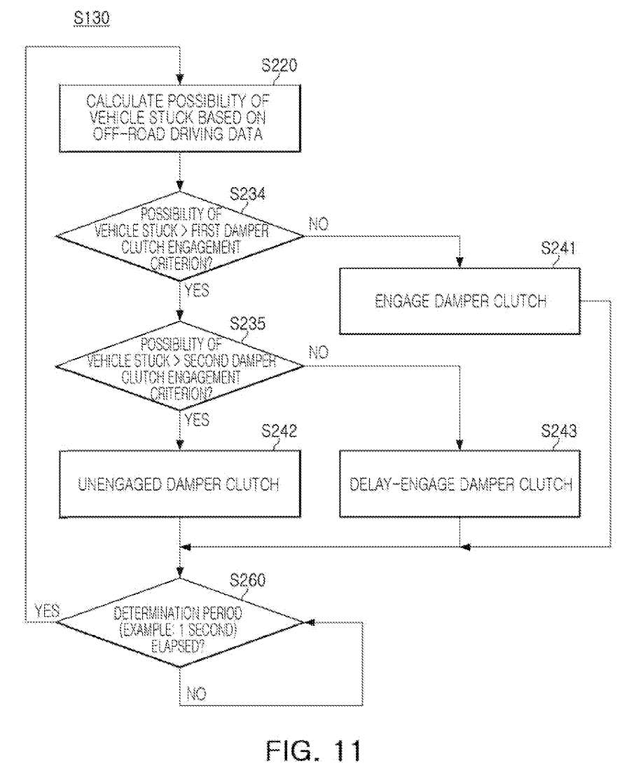

Referring to FIGS. 10 and 11, the damper clutch engagement control logic may be configured so that when the possibility of vehicle stuck is higher than the second damper clutch engagement criterion YES in S235, the controller is configured to control the damper clutch to be in an unengaged state S242, when the possibility of vehicle stuck is lower than the second damper clutch engagement criterion NO in S235 or NO in S234, the controller is configured to control the damper clutch to an engaged state S241 or S243, and when the possibility of vehicle stuck is higher than the first damper clutch engagement criterion YES in S234 compared to when the possibility of vehicle stuck is lower than the first damper clutch engagement criterion NO in S234, the controller may further delay and control the damper clutch to an engaged state S242.

For example, a change in the engagement time (e.g., delayed engagement, rapid engagement) may be implemented as a change in the engagement time of a separate logic controlling whether the damper clutch is engaged (e.g., control logic of the terrain mode or logic of changing whether the damper clutch is engaged when the gear shifting level changes between second and third gears), but is not limited thereto.

Meanwhile, referring to FIG. 3, the controller 500 may be implemented as a computing system including at least one processor 501, a computer-readable storage medium 502, and a communication bus 503. For example, the controller 500 may be implemented as a microcontroller, an embedded system, a system on chip, etc. The storage medium 502 may record one or more programs including commands for executing a method for supporting off-road driving according to an exemplary embodiment of the present disclosure. The communication bus 503 may interconnect various other components of the computing device 500, including the processor 501 and the computer-readable storage medium 502.

The processor 501 may cause the controller 500 to operate according to the exemplary embodiments described above. For example, the processor 501 may execute one or more programs stored on the computer-readable storage medium 502. The one or more programs may include one or more computer-executable instructions, which, when executed by the processor 501, may be configured to cause the controller 500 to perform operations according to the embodiments.

The computer-readable storage medium 502 may be configured to store computer-executable instructions or program code, program data, and/or other suitable forms of information. A program 502a stored on the computer-readable storage medium 502 includes a set of instructions executable by the processor 501. In an exemplary embodiment of the present disclosure, the computer-readable storage medium 502 may be memory (volatile memory, such as random access memory, nonvolatile memory, or a suitable combination thereof), one or more magnetic disk storage devices, optical disk storage devices, flash memory devices, or any other form of storage medium which may be accessed by the controller 500 and configured for storing target information, or a suitable combination thereof.

The controller 500 may also include one or more input/output interfaces 505 providing an interface for one or more input/output devices 504 and one or more network communication interfaces 506. The input/output interfaces 505 and the network communication interfaces 506 are connected to the communication bus 503. The network may be one of a cellular network, such as Global System for Mobile Communications (GSM), Enhanced Data Rates for GSM Evolution (EDGE), General Packet Radio Service (GPRS), Code Division Multiple Access (CDMA), Time Division-CDMA (TD-CDMA), Universal Mobile Telecommunications System (UMTS), Long Term Evolution (LTE), 5G, Wi-Fi, or another cellular network, and may also be implemented as Ethernet, Media Oriented Systems Transport (MOST), Flexray, Controller region Network (CAN), Local Interconnect Network (LIN), Internet, Bluetooth, Near Field Communication (NFC), Zigbee, Radio Frequency (RF), etc.

The input/output device 504 may be connected to other components of the controller 500 via the input/output interface 505. The input/output devices 504 may include, for example, input devices, such as pointing devices (such as a mouse or trackpad), keyboards, touch input devices (such as a touchpad or a touchscreen), voice or sound input devices, various types of sensor devices and/or image capturing devices, and/or output devices, such as display devices, printers, speakers, and/or network cards. For example, the input/output devices 504 may be included inside the controller 500 as a component forming the controller 500 or may be connected to the controller 500 as a separate device distinct from the controller 500.

Meanwhile, the embodiments of the present disclosure may include a program for performing the methods described in this specification on a computer and a computer-readable recording medium including the program. The computer-readable recording medium may include program instructions, local data files, local data structures, etc., alone or in combination. The medium may be those specifically designed and configured for the present disclosure or may be those commonly available in the computer software field. Examples of computer-readable recording medium include magnetic medium, such as hard disks, floppy disks, and magnetic tapes, optical recording medium, such as CD-ROMs, DVDs, and hardware devices specifically configured to store and perform program instructions, such as ROM, RAM, flash memory, etc. Examples of the program may include not only machine language code, such as that generated by a compiler, but also high-level language code which may be executed by a computer using an interpreter or the like.

The apparatus and method for supporting off-road driving and the vehicle and storage medium including the same according to an exemplary embodiment of the present disclosure may prevent the temperature rise of transmission oil of the torque converter, while effectively reducing the overall final possibility of vehicle stuck on off-road even when the road surface severity of the off-road terrain varies. Furthermore, by preventing the temperature rise of transmission oil, the automatic transmission may be prevented from being damaged by heat and the lifespan of the automatic transmission may also be lengthened.

For example, when the temperature of the transmission oil is too high, the damper clutch may be controlled to the engaged state preferentially according to a separate transmission protection logic, and here, the apparatus and method for supporting off-road driving and the vehicle and storage medium including the same according to an exemplary embodiment of the present disclosure may prevent unnecessary increases in the temperature of the transmission oil whenever the possibility of vehicle stuck is low, minimizing the occurrence of a situation in which both the temperature of the transmission oil and the possibility of the vehicle stuck are high and stably reducing the possibility of the final vehicle stuck.

While embodiments have been shown and described above, it will be apparent to those skilled in the art that modifications and variations could be made without departing from the scope of the present disclosure as defined by the appended claims.

What is claimed is:

1. An apparatus for supporting off-road driving, the apparatus comprising:
a controller configured to receive off-road driving data of a vehicle and control whether or when to engage a damper clutch of the vehicle according to damper clutch engagement control data by applying the off-road driving data to a damper clutch engagement control logic,
wherein the damper clutch engagement control logic is configured so that whether or when to engage the damper clutch varies according to a possibility of vehicle stuck in off-road terrain based on the off-road driving data.

2. The apparatus of claim 1, wherein the damper clutch engagement control logic is configured so that when the possibility of vehicle stuck is lower than a damper clutch engagement criterion, the controller is further configured to control the damper clutch to an engaged state, and when the possibility of vehicle stuck is higher than the damper clutch engagement criterion, the controller is further configured to control the damper clutch to be in an unengaged state.

3. The apparatus of claim 2,
wherein the damper clutch engagement criterion includes a first damper clutch engagement criterion and a second damper clutch engagement criterion higher than the first damper clutch engagement criterion, and
wherein the damper clutch engagement control logic is configured so that when the possibility of vehicle stuck is higher than the second damper clutch engagement criterion, the controller is further configured to control the damper clutch to be in an unengaged state, and when the possibility of vehicle stuck is lower than the second damper clutch engagement criterion, the controller is further configured to control the damper clutch to an engaged state, and
wherein when the possibility of vehicle stuck is higher than the first damper clutch engagement criterion compared to when the possibility of vehicle stuck is lower than the first damper clutch engagement criterion, the controller is further configured to control the damper clutch to an engaged state by further delaying the damper clutch.

4. The apparatus of claim 2,
wherein the controller is further configured to receive gear shifting level data of the vehicle, and
wherein the damper clutch engagement control logic is configured so that the damper clutch engagement criterion increases as a gear shifting level of the vehicle increases.

5. The apparatus of claim 4,
wherein the controller configures off-road type data of the vehicle, and
wherein the damper clutch engagement control logic is configured to determine the damper clutch engagement criterion according to the off-road type data of the vehicle.

6. The apparatus of claim 5,
wherein the off-road type data includes at least two of snow type data corresponding to a snowy road, sand type data corresponding to a sandy road, or mud type data corresponding to a muddy road,
wherein the controller is further configured to store a plurality of damper clutch engagement criterion sets,
wherein the plurality of damper clutch engagement criterion sets include at least two of a snow type damper clutch engagement criterion set, a sand type damper clutch engagement criterion set, or a mud type damper clutch engagement criterion set, and
wherein the damper clutch engagement control logic is configured to select one of the plurality of damper clutch engagement criterion sets according to the off-road type data and vary whether to engage the damper clutch based on the damper clutch engagement criterion determined according to the gear shifting level of the vehicle and the possibility of vehicle stuck in the selected damper clutch engagement criterion set.

7. The apparatus of claim 1, wherein the damper clutch engagement control logic is configured so that whether or when the damper clutch is engaged varies depending on an off-road type of the vehicle and the possibility of vehicle stuck.

8. The apparatus of claim 7,
wherein the controller is further configured to receive gear shifting level data of the vehicle, and
wherein the damper clutch engagement control logic is configured to vary whether or when the damper clutch is engaged depending on a gear shifting level of the vehicle, the off-road type, and the possibility of vehicle stuck.

9. The apparatus of claim 1,
wherein the controller is further configured to receive the off-road driving data from a sensor unit, and
wherein the off-road driving data includes at least one of a speed of the vehicle, acceleration of the vehicle, a yaw rate of the vehicle, a yaw acceleration of the vehicle, a steering angle of the vehicle, a number of rotations of a wheel of the vehicle, a torque of the vehicle, or an acceleration input value of the vehicle.

10. The apparatus of claim 9,
wherein the damper clutch engagement control logic is configured to periodically determine whether or when to engage the damper clutch at every predetermined determination period, and
wherein the determination period is less than 10 seconds.

11. The apparatus of claim 9,
wherein the damper clutch engagement control logic is configured to selectively control whether or when to engage the damper clutch depending on whether an off-road driving mode is used, and
wherein the controller is further configured to determine whether to use the off-road driving mode, either manually according to an input or automatically based on the off-road driving data.

12. A method for supporting off-road driving, the method comprising:
storing a damper clutch engagement control logic of a vehicle based on a possibility of vehicle stuck in off-road terrain;
receiving off-road driving data of the vehicle; and
controlling whether or when to engage a damper clutch of the vehicle by applying the off-road driving data to the damper clutch engagement control logic.

13. The method of claim 12, wherein the damper clutch engagement control logic is configured to control the damper clutch to an engaged state when the possibility of vehicle stuck is lower than a damper clutch engagement criterion and to control the damper clutch to an unengaged state when the possibility of vehicle stuck is higher than the damper clutch engagement criterion.

14. The method of claim 13,
wherein the receiving includes receiving gear shifting level data of the vehicle, and
wherein the damper clutch engagement control logic is configured so that the damper clutch engagement criterion is determined according to a gear shifting level of the vehicle and off-road type.

15. The method of claim 14,
wherein the off-road type data includes at least two of snow type data corresponding to a snowy road, sand type data corresponding to a sandy road, or mud type data corresponding to a muddy road,
wherein the storing includes storing a plurality of damper clutch engagement criterion sets,
wherein the plurality of damper clutch engagement criterion sets include at least two of a snow type damper clutch engagement criterion set, a sand type damper clutch engagement criterion set, or a mud type damper clutch engagement criterion set, and
wherein the damper clutch engagement control logic is configured to select one of the plurality of damper clutch engagement criterion sets according to the off-road type data and vary whether to engage the damper clutch based on the damper clutch engagement criterion determined according to the gear shifting level of the vehicle and the possibility of vehicle stuck in the selected damper clutch engagement criterion set.

16. A storage medium having recorded thereon one or more programs including instructions for executing the method for supporting off-road driving of claim 12.

17. A vehicle comprising:
a controller including a processor and a storage medium having recorded thereon one or more programs configured to be executable by the processor,
wherein the one or more programs include instructions for executing the method for supporting the off-road driving of claim 12.

18. A vehicle comprising:
an automatic transmission including a damper clutch and a torque converter;
a sensor unit sensing off-road driving data; and
a controller configured to control whether or when to engage the damper clutch according to damper clutch engagement control data by applying the off-road driving data to a damper clutch engagement control logic,
wherein the damper clutch engagement control logic is configured to vary whether or when to engage the damper clutch according to a possibility of vehicle stuck in off-road terrain based on the off-road driving data.

19. The vehicle of claim 18,
wherein the controller is further configured to receive gear shifting level data of the vehicle from the sensor unit, and
wherein the damper clutch engagement control logic is configured to vary whether or when to engage the damper clutch depending on a gear shifting level of the vehicle, an off-road type, and the possibility of vehicle stuck.

20. The vehicle of claim 19, wherein the damper clutch engagement control logic is configured so that when the possibility of vehicle stuck is lower than a damper clutch engagement criterion, the controller is configured to control the damper clutch to an engaged state, and when the possibility of vehicle stuck is higher than the damper clutch engagement criterion, the controller is configured to control the damper clutch to be in an unengaged state.
